(19) United States
(12) Patent Application Publication
(10) Pub. No.: US 2023/0043313 A1
(43) Pub. Date: Feb. 9, 2023

(54) FIRMWARE UPDATE SHARED KEY MANAGEMENT METHOD USING FLASH MEMORY AND COMPUTER PROGRAM STORED IN RECORDING MEDIA FOR EXECUTING THE SAME

(71) Applicant: Security Platform Inc., Seongnam-si (KR)

(72) Inventor: Kyung Tae HAN, Seoul (KR)

(21) Appl. No.: 17/506,837

(22) Filed: Oct. 21, 2021

(30) Foreign Application Priority Data
Aug. 3, 2021 (KR) 10-2021-0102088

(51) Int. Cl. G06F 8/65; H04L 9/08

(52) U.S. Cl. CPC G06F 8/65; H04L 9/088

(57) ABSTRACT

A firmware update shared key management method using a flash memory includes: a firmware data registration step of receiving, from a manufacturer server, at least one of information of a user device that is a firmware update target, and firmware information and registering the received information as firmware data; a firmware data management step of receiving a request from a firmware update server in which the registered firmware data is stored, and storing and managing the registered firmware data in a specific area of a flash memory included in the user device via a network; a shared key verification execution step of using a shared key to execute verification on a command communicating between the user device including the flash memory and the firmware update server that performs firmware update; and a firmware update execution step of performing firmware update of the user device through the firmware update server only when the encrypted command and the shared key pass the verification.

### CROSS-REFERENCE TO RELATED APPLICATION

This application claims the benefit of Korean Patent Application No. 10-2021-0102088, filed on Aug. 3, 2021, in the Korean Intellectual Property Office, the disclosure of which is incorporated herein in its entirety by reference.

### BACKGROUND

### 1. Field

The present invention relates to a firmware update shared key management method using a flash memory and a computer program stored in a recording media for executing the same, and more particularly, to a firmware update shared key management method using a flash memory and a computer program stored in a recording media for executing the same, wherein, when data is exchanged between a server and a client by using Micron's Authenta Flash, data is encrypted and transmitted by using a previously shared key in order to protect data safely, so that data cannot be decrypted even if data is intercepted in the middle.

### 2. Description of Related Art

Software for performing various functions is incorporated in an electronic device. The software is referred to as embedded software or firmware. With the rapid development of processors, the role of firmware is also increasing in various ways.

In general, firmware is continuously implemented so as to reflect additional customer requirements or solve problems inherent in hardware or software, and firmware update of a device is made in various ways including wired and wireless methods.

However, malfunctions of devices may be caused due to defective firmware. In this case, firmware update is required. In addition, firmware update is required in a process of updating hardware of devices.

However, in practice, it takes a lot of time and cost to update firmware of devices. In consideration of this point, there is a need for a technology for updating firmware by using a communication network. Recently, a technology for updating firmware by using a communication network has been introduced, but only a simple firmware update is introduced, and the reliability or stability of the update is not guaranteed.

Therefore, there is an urgent need for a firmware update shared key management method using a flash memory and a computer program stored in a recording media for executing the same, wherein, when data is exchanged between a server and a client by using Micron's Authenta Flash in order to secure reliability and stability of update, data is encrypted and transmitted by using a previously shared key in order to protect data safely, so that data cannot be decrypted even if data is intercepted in the middle.

### CITATION LIST

### Patent Literature

(Patent Literature 0001) Korean Patent Laid-Open No. 10-2017-0056018

(Patent Literature 0002) Korean Patent Laid-Open No. 10-2021-0027499

### SUMMARY

The present invention has been made in an effort to solve the problems of the related art, and an object of the present invention is to provide a firmware update shared key management method and a computer program stored in a recording media for executing the same, wherein a server that transmits a command to a device in which Authenta flash is installed stores a key shared with the device in a file in advance, and it is possible to store the key safely by managing the key used to encrypt an Authenta flash command in a hardware security module (HSM) of a separate server, while overcoming an environment where, when a key file stored in a server device is leaked to the outside, it is possible to intercept and decrypt the encrypted and exchanged data, and thus, a command to install malicious code on a device in which Authenta flash is installed, leaving the device at risk.

However, the technical problems to be achieved by the present embodiment are not limited to the technical problems described above, and other technical problems may exist.

In order to achieve the objects, the present invention includes: a firmware data registration step of receiving, from a manufacturer server, at least one of information of a user device that is a firmware update target, and firmware information and registering the received information as firmware data; a firmware data management step of receiving a request from a firmware update server in which the registered firmware data is stored, and storing and managing the registered firmware data in a specific area of a flash memory included in the user device via a network; a shared key verification execution step of using a shared key to execute verification on a command communicating between the user device including the flash memory and the firmware update server that performs firmware update; and a firmware update execution step of performing firmware update of the user device through the firmware update server only when the encrypted command and the shared key pass the verification.

In addition, the shared key verification execution step includes managing the shared key through at least one of a hardware security module (HSM) and a key management system (KMS) included in a separate signature generation/verification server that performs at least one of signature generation and verification on the managed firmware data.

In addition, the step shared key verification execution step includes, when the firmware update server transmits a command to the user device including the flash memory, performing network communication with the signature generation/verification server based on a Transport Layer Security (TLS) protocol.

In addition, the shared key verification execution step includes, when TLS network communication is successful, transmitting data required to generate the signature to the signature generation/verification server via the network.

In addition, the shared key verification execution step includes generating the signature from the data received by the signature generation/verification server, based on the shared key managed through at least one an HSM and a KMS.

In addition, the shared key verification execution step includes transmitting the result of the generated signature to the firmware update server through the TLS network communication.

In addition, the shared key verification execution step includes, when the user device including the flash memory receives a response to the command through the firmware update server, transmitting a signature value and a response value to the signature generation/verification server.

In addition, in the shared key verification execution step, the signature generation/verification server verifies the signature based on the shared key managed through at least one of an HSM and a KMS, and transmits the result of the verified signature to the firmware update server through TLS network communication.

In addition, the firmware data management step includes configuring the network based on a gRPC (gRPC Remote Procedure Calls) protocol.

In addition, the firmware data management step includes receiving a request from the user device to store the registered firmware data in the specific area of the flash memory through an update application included in the firmware update server.

In addition, the firmware data management step includes storing and managing the registered firmware data in the specific area of the flash memory as a firmware image.

In addition, the present invention provides a computer program stored in a recording media for executing the above-described method.

### BRIEF DESCRIPTION OF DRAWINGS

FIG. 1 is a flowchart of a firmware update shared key management method using a flash memory according to an embodiment of the present invention.

FIG. 2 is a conceptual diagram of a firmware update shared key management method using a flash memory according to an embodiment of the present invention.

FIG. 3 is an exemplary view of a flash memory used in a firmware update security method using a flash memory according to an embodiment of the present invention.

### DETAILED DESCRIPTION

The terms or words used in the present specification and the claims should not be construed as being limited to ordinary or dictionary meanings. The inventors should be construed as meanings and concepts consistent with the technical idea of the present invention, based on the principle that the concept of the terms can be appropriately defined in order to explain their invention in the best way.

The configuration shown in the embodiments and drawings described in this specification is only the most preferred embodiment of the present invention, and does not represent all the technical idea of the present invention. Therefore, it should be understood that various equivalents and modifications may be substituted for them at the time of filing the present application.

The terms as used herein are those defined by taking into account functions in the present invention, but the terms may vary depending on the intention of producers, precedents, or the like. Therefore, the definitions should be made based on the contents throughout the specification. When the detailed description of the relevant known functions or configurations is determined to unnecessarily obscure the gist of the present invention, the detailed description thereof may be omitted.

Hereinafter, a firmware update shared key management method using a flash memory and a computer program stored in a recording media for executing the same according to the present invention will be described with reference to the drawings.

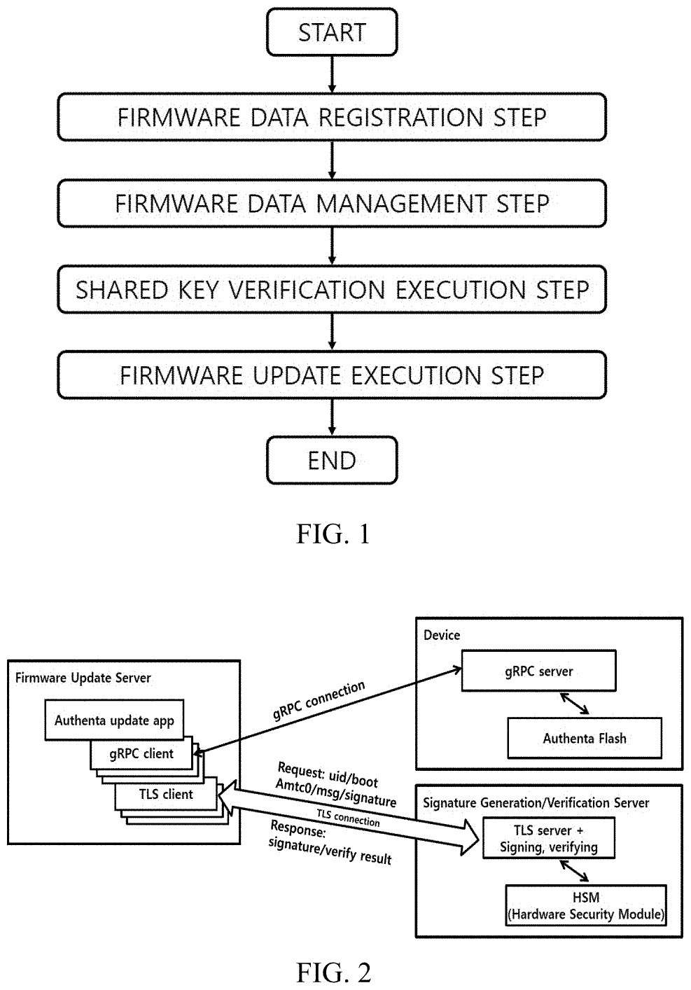

FIG. 1 is a flowchart of a firmware update shared key management method using a flash memory according to an embodiment of the present invention.

The method may basically include a firmware data registration step, a firmware data management step, a shared key verification execution step, and a firmware update execution step.

More specifically, a firmware update shared key management method includes: a firmware data registration step of receiving, from a manufacturer server, at least one of information of a user device that is a firmware update target, and firmware information and registering the received information as firmware data; a firmware data management step of receiving a request from a firmware update server in which the registered firmware data is stored, and storing and managing the registered firmware data in a specific area of a flash memory included in the user device via a network; a shared key verification execution step of using a shared key to execute verification on a command communicating between the user device including the flash memory and the firmware update server that performs firmware update; and a firmware update execution step of performing firmware update of the user device through the firmware update server only when the encrypted command and the shared key pass the verification.

In addition, the method according to the present invention may be performed in a server. The server may be configured to serve as a web server, a database server, or a mobile server. For example, the server may display a processing result on a webpage through an online network, or may receive necessary input data through a webpage. The webpage may include software for performing a specific task such as a web application as well as simple text, image, sound, video, and the like.

In addition, the server may be configured to provide an interface and an application installed on desktop, laptop, smartphone, tablet personal computer (PC), and the like.

In addition, the online network as used in the present invention may be a core network that is integrated with a wired public network, a wireless mobile communication network, or a portable Internet, or may refer to a worldwide open computer network architecture that provides TCP/IP protocol and several services existing in upper layers thereof, that is, Hyper Text Transfer Protocol (HTTP), Hyper Text Transfer Protocol Secure (HTTPS), Telnet, File Transfer Protocol (FTP), Domain Name System (DNS), Simple Mail Transfer Protocol (SMTP), or the like. However, the online network is not limited to these examples, and may comprehensively refer to a data communication network capable of transmitting and receiving data in various forms.

In addition, the server may exchange and manage data through a transmission medium such as a metal wire, a waveguide, or light including a carrier wave for transmitting a signal designating a program instruction, a data structure, or the like. Examples of the program instruction made in the server may include not only machine code that is generated by a compiler, but also high-level language code that may be executed by a device (e.g., a computer) that electronically processes information by using an interpreter. The hardware devices of the servers may be configured to operate as one or more software modules so as to perform the operations of the present invention, and vice versa.

In addition, a user device described below may include at least one of smartphone, tablet PC, mobile phone, video phone, desktop PC, laptop PC, netbook computer, personal digital assistant (PDA), portable multimedia plater (PMP), wearable device (e.g., smart glasses, head-mounted-device (HMD), etc.), smart mirrors, kiosk devices, or smart watch. The user device is not limited to these examples, and refers to devices capable of transmitting and receiving a value of an electrically changed signal in various forms.

In addition, examples of the user device may include an input module. The input module may include a plurality of input keys and function keys for receiving numeric or character information and setting various functions. The function keys may include direction keys, side keys, and shortcut keys, which are set to perform specific functions. The input module may generate a key signal related to function control of the user device and transmit the generated key to the user device.

In addition, when the user device supports a full touch screen, the user device may include only a volume key for volume control and a power key for screen on/off and device on/off, which are formed on a side of a case of the user device. In particular, the user device may access the server described in the present invention, generate various input signals such as input signals for executing, controlling, and instructing firmware update, and transmit the input signals to the server described in the present invention.

In addition, examples of the user device may include a user device control module. The user device control module may control overall operations of a user device firmware management method to be received by the user device and a signal flow between internal blocks of the user device, and may also perform a data processing function. The user device control module may include a central processing unit (CPU), an application processor, a software development kit (SDK), and the like. However, the user device control module is not limited to these examples, and may comprehensively refer to a module capable of controlling the user device in various forms.

In addition, the firmware data registration step may include receiving, from the manufacturer server, at least one of information of the user device that is the firmware update target, firmware information, and signature key information, and registering the received information as firmware data.

In addition, the firmware data registration step may further include a data synchronization step of synchronizing data so that the registered data corresponds to the information data of at least one of the information of the user device that is the firmware update target of the manufacturer server, the firmware information, and the signature key information.

In addition, the firmware data registration step may include registering a firmware update target device and module type information of the device. The firmware data registration step may include accessing a device/module type registration page through the manufacturer server, inquiring about a list of module types, inputting device/module type information through the manufacturer server, performing device/module type duplication check, receiving a registration request from the manufacturer server, and storing the device/module type information of the device that is the firmware update target.

The module list of the device is for consistently updating the modules included in the device by type, and may indicate module name, device type (e.g., DCU, PLC, LTE, MCU, etc.), detailed module information (firmware information), etc.

In addition, the device list may indicate module identifier ID, device name, manufacturer, device model, serial number, device access information (IP), device physical information, registration date, detailed device information (firmware information), etc.

In addition, in the firmware data registration step, the firmware information may be registered by the user device that is the firmware update target. The device list and the firmware management information may be inquired through the firmware registration page of the manufacturer server, the device may be selected from the manufacturer server to configure the device information, and the module type information included in the device may be inquired.

In addition, in the firmware data registration step, the firmware information may be registered by the module that is the firmware update target. The manufacturer server may select a module based on the inquired module type information and inquire the firmware list. When firmware data is input from the manufacturer server, firmware duplication may be checked. Therefore, the registration request may be received from the manufacturer server and the firmware information may be stored.

The firmware management information may indicate device identifier ID (firmware management for each module), current firmware identifier ID, DIFF image identifier ID, signature key identifier, update scheduling activation or non-activation, integrity verification scheduling activation or non-activation, new firmware registration or non-registration, last update date, last Integrity check schedule, final integrity check value, and the like.

In addition, the firmware information may indicate device identifier, main module firmware ID, firmware version, firmware data, corresponding data size, firmware data integrity value, registration time, and the like.

In addition, in the firmware data management step, the network is configured based on gRPC (gRPC Remote Procedure Calls) protocol. In the shared key verification execution step, network communication is performed between the firmware update server and the signature generation/verification server based on a Transport Layer Security (TLS) protocol.

In addition, the network includes various communication protocols, and information exchanged between devices through the network or other media is managed according to rules that can be set in the communication protocol specification.

In addition, the nature of the communication, the actual exchanged data, and the behavior according to any state are defined by this specification. In digital computing systems, rules can be expressed as algorithms and data structures. The protocol is a computation and communication of an algorithm or programming language.

In addition, operating systems usually have a set of collaborative processes that communicate with each other by manipulating shared data. This communication is controlled by a well-understood protocol that may be embedded in the process code itself. In contrast, since there is no shared memory, communication systems must communicate with each other by using a shared transmission medium. The transmission is not necessarily reliable and individual systems may use different hardware or operating systems.

In addition, in order to implement a networking protocol, a protocol software module interfaces with a framework implemented in the operating system of the machine. This framework implements the networking functions of the operating system. When the protocol algorithm is expressed in portable programming languages, the protocol software may be independent of the operating system, and the most well-known frameworks are a TCP/IP model and an OSI model.

In addition, the transmission is not processed by using a single protocol. Instead, a set of collaborative protocols called protocol suite is used. The best known protocol suite is TCP/IP, IPX/SPX, X.25, AX.25, and AppleTalk.

In addition, the protocols may be ordered based on the functionality of the group. For example, there is a transport protocol group. Functions are mapped to layers, and each layer solves a distinct class of problems related to application, transport, Internet, and network interface functions. In addition, in order to transmit a message, a protocol must be selected at each layer. The selection of the next protocol is achieved by extending the message with a protocol selector for each layer.

In addition, examples of the various communication protocols may include Hyper Text Transfer Protocol (HTTP), Hyper Text Transfer Protocol Secure (HTTPS), File Transfer Protocol (FTP), Secure File Transfer Protocol (SFTP), Telnet (Terminal Network), Post Office Protocol version 3 (POP3), Simple Mail Transfer Protocol (SMTP), Secure Shell (SSH), Secure Socket Layer (SSL), Simple Object Access Protocol (SOAP), Address Resolution Protocol (ARP), and the like. However, the communication protocols are not limited to these examples, and may comprehensively refer to any communication protocols of various types commonly known.

In addition, in the firmware data management step, a request to store the registered firmware data in a specific area of the flash memory is received from the user device through the update application included in the firmware update server. In the firmware data management step, the registered firmware data is stored and managed as a firmware image in a specific area of the flash memory. In the firmware update execution step, the firmware update is executed based on the firmware image.

In addition, the flash memory is Micron's Authenta Flash. Micron stores the device's unique key on a Flash Drive, and provides Authenta technology that utilizes a DICE function of generating a new device ID by reflecting a hash value of a firmware code as a method for preventing deterioration of security functions due to the use of modified firmware that may occur during the firmware update process.

In addition, unique password information is embedded in a non-volatile memory. When firmware is updated, this password information is calculated and changed with the unique value included in the firmware. An external management server may also verify the integrity of the firmware applied to the device while decoding the password information through the authentication process. Therefore, it is a technology that has the advantage of making it more difficult to apply malicious firmware in a detour method.

In addition, in the shared key verification execution step, the shared key is managed through at least one of a hardware security module (HSM) and a key management system (KMS) included in a separate signature generation/verification server that performs at least one of signature generation and verification for the managed firmware data. For example, the shared key may be managed through the HSM included in the separate signature generation/verification server that performs at least one of signature generation and verification for the managed firmware data.

In addition, when the firmware update server that performs the firmware update transmits a command to the user device including the flash memory (Authenta flash), Transport Layer Security (TLS) communication with the signature generation/verification server is performed. In the shared key verification execution step, when the firmware update server that performs the firmware update transmits the command to the user device including the flash memory, network communication with the signature generation/verification server is performed based on the TLS protocol.

In addition, in the shared key verification execution step, when the TLS network communication is successful, data required to generate the signature is transmitted to the signature generation/verification server through the network. Data such as UID, boot amtc0, message (command), or the like may be transmitted.

In addition, the signature generation/verification server may generate the signature from the received data by using the shared key stored (managed) in at least one of the HSM and the KMS, and may transmit the result to the firmware update server that performs the firmware update over the TLS channel.

Therefore, in the shared key verification execution step, the signature generation/verification server generates the signature from the received data required to generate the signature, based on the shared key managed through at least one of the HSM and the KMS. In the shared key verification execution step, the result of the generated signature is transmitted to the firmware update server that performs the firmware update through TLS network communication.

In addition, when a response to the command is received from the user device, a signature value and a response value must be transmitted together to the signature generation/verification server. Therefore, in the shared key verification execution step, when the user device including the flash memory receives the response to the command through the firmware update server that performs the firmware update, the signature value and the response value are transmitted to the signature generation/verification server. Data such as UID, boot amtc0, message (command), and signature may be transmitted.

In addition, the signature generation/verification server may verify the signature by using the shared key stored (managed) in at least one of the HSM and the KMS, and may transmit the result to the firmware update server that performs the firmware update, and the firmware update server may perform the user device update operation by referring to the response value of the signature generation/verification server.

Therefore, in the shared key verification execution step, the signature generation/verification server verifies the signature based on the shared key managed through at least one of the HSM and the KMS, and transmits the result of the verified signature to the firmware update server through TLS network communication.

In addition, the above-described method according to the present invention may be implemented in the form of program instructions that can be executed through various computer means, and may be recorded on a computer-readable recording medium. The computer-readable recording medium may include program instructions, data files, data structures, and the like alone or in combination. The program instructions recorded on the recording medium may be specially designed and configured for the present invention, or may be known and available to those of ordinary skill in the art in the technical field of computer software.

In addition, examples of the computer-readable recording medium may include magnetic media such as hard disk, floppy disk, and magnetic tape, optical media such as CD-ROM and DVD, magneto-optical media such as floptical disk, and hardware device specially configured to store and execute program instructions, such as ROM, RAM, flash memory.

Furthermore, examples of the program instructions may include not only machine language codes generated by a compiler, but also high-level language codes that can be executed using an interpreter by a computer. The hardware device described above may be configured to operate as one or more software modules so as to perform the operations of the present invention, and vice versa.

In addition, it can be seen that the present invention can be realized in the form of hardware, software, or a combination of hardware and software. Regardless of whether erasable or rewritable, such software may be store in volatile or non-volatile storage devices, memory such as RAM, memory chip, or integrated circuit, or storage media such as CD, DVD, magnetic disk, or magnetic tape, etc., which can record data optically and magnetically and can read data by a machine (e.g., a computer).

Therefore, the present invention includes a program including code for implementing the above-described method and a machine-readable storage media storing such a program. Such a program may be transported electronically over any media such as a communication signal carried over a wired or wireless connection. The present invention suitably includes equivalents thereto.

FIG. 2 is a conceptual diagram of a firmware update shared key management method using a flash memory according to an embodiment of the present invention.

More specifically, the command is encrypted with the previously shared key and transmitted, the received command is verified with the shared key, and only when there is no problem, the firmware update server and the device in which the Authenta flash is installed communicate with each other.

In addition, a separate signature generation/verification server is provided to request signature generation and verification whenever necessary while managing the shared key through the HSM in the server.

In addition, when data is transmitted between the firmware update server and the signature server, the data is safely exchanged through a TLS connection, thereby preventing leakage or falsification of the signature or verification result. Therefore, the key may be safely stored, and the command transmitted and received with the Authenta flash device can be safely delivered.

In addition, gRPC (Remote Procedure Calls) protocol is used for communication between the firmware update server and the device.

In addition, when a gRPC client that performs gRPC communication generates a command and transmits the command to a gRPC server, the gRPC server transmits the command to the Authenta flash and writes data to the flash.

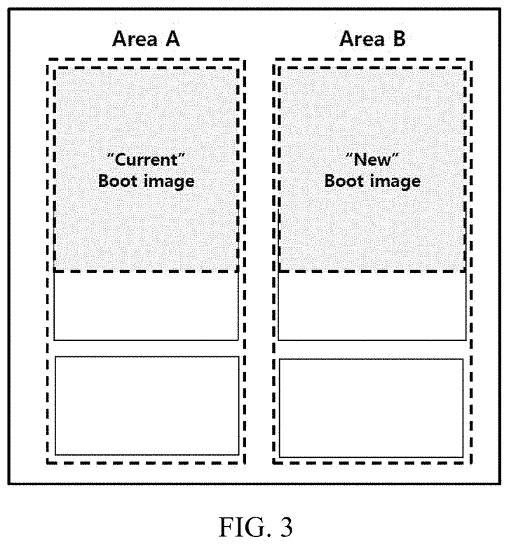

FIG. 3 is an exemplary view of a flash memory used in a firmware update security method using a flash memory according to an embodiment of the present invention.

1. The boot Image is stored in area A of the Authenta flash memory and the device is configured to operate using the image.

2. Area A is set to AM block, and data cannot be written by general access.

3. When a situation that must change the boot image occurs, the new boot image is written to area B by using the following commands.

DYB_Write: Unlock the legacy block

Subsector_Erase: Erase data

Page_Program: Write image data

DYB_Write: Lock the legacy block

4. The image written to area B, i.e., the legacy block, is copied to area A, i.e., the AM block.

Auth_modify: Copy the image from area B to area A.

Measure: Obtain the hash value of the image written to area A.

5. It is checked whether the hash value of the image written to area A is the same as the hash value of the new boot Image.

6. The device is reset to confirm that the device operates with “New” boot Image.

In the firmware update shared key management method using the flash memory and the computer program stored in the recording media for executing the same according to the present invention, it is possible to store the key safely by managing the key used to encrypt the Authenta flash command in the HSM of the separate server.

In addition, based on the above effects, the key can be safely stored and managed, and the device in which the Authenta flash is installed can be safely managed.

However, the effects of the present invention are not limited to those described above, and the effects not mentioned will be clearly understood from the present specification and accompanying drawings by those of ordinary skill in the art.

The present invention has been described with reference to the accompanying drawings, focusing on the specific shape and direction. However, various modifications and changes can be made thereto by those of ordinary skill in the art. Such modifications and changes should be construed as falling within the scope of the present invention.

What is claimed is:

1. A firmware update shared key management method comprising:
a firmware data registration step of receiving, from a manufacturer server, at least one of information of a user device that is a firmware update target, and firmware information and registering the received information as firmware data;
a firmware data management step of receiving a request from a firmware update server in which the registered firmware data is stored, and storing and managing the registered firmware data in a specific area of a flash memory included in the user device via a network;
a shared key verification execution step of using a shared key to execute verification on a command communicating between the user device including the flash memory and the firmware update server that performs firmware update; and
a firmware update execution step of performing firmware update of the user device through the firmware update server only when the encrypted command and the shared key pass the verification.

2. The firmware update shared key management method of claim 1, wherein the shared key verification execution step comprises managing the shared key through at least one of a hardware security module (HSM) and a key management system (KMS) included in a separate signature generation/verification server that performs at least one of signature generation and verification on the managed firmware data.

3. The firmware update shared key management method of claim 2, wherein the step shared key verification execution step comprises, when the firmware update server transmits a command to the user device including the flash memory, performing network communication with the signature generation/verification server based on a Transport Layer Security (TLS) protocol.

4. The firmware update shared key management method of claim 3, wherein the shared key verification execution step comprises, when TLS network communication is successful, transmitting data required to generate the signature to the signature generation/verification server via the network.

5. The firmware update shared key management method of claim 4, wherein the shared key verification execution step comprises generating the signature from the data received by the signature generation/verification server, based on the shared key managed through at least one an HSM and a KMS.

6. The firmware update shared key management method of claim 5, wherein the shared key verification execution step comprises transmitting the result of the generated signature to the firmware update server through the TLS network communication.

7. The firmware update shared key management method of claim 3, wherein the shared key verification execution step comprises, when the user device including the flash memory receives a response to the command through the firmware update server, transmitting a signature value and a response value to the signature generation/verification server.

8. The firmware update shared key management method of claim 2, wherein, in the shared key verification execution step, the signature generation/verification server verifies the signature based on the shared key managed through at least one of an HSM and a KMS, and transmits the result of the verified signature to the firmware update server through TLS network communication.

9. The firmware update shared key management method of claim 1, wherein the firmware data management step comprises configuring the network based on a gRPC (gRPC Remote Procedure Calls) protocol.

10. The firmware update shared key management method of claim 1, wherein the firmware data management step comprises receiving a request from the user device to store the registered firmware data in the specific area of the flash memory through an update application included in the firmware update server.

11. The firmware update shared key management method of claim 1, wherein the firmware data management step comprises storing and managing the registered firmware data in the specific area of the flash memory as a firmware image.

12. A computer program stored in a recording media for executing the method according to claim 1.
